(19) United States
(12) Patent Application Publication
(10) Pub. No.: US 2025/0343436 A1
(43) Pub. Date: Nov. 6, 2025

(54) ENERGY SAVING SYSTEM AND METHOD

(71) Applicant: Anthony Jeremiah Bayne, lomita, CA (US)

(72) Inventor: Anthony Jeremiah Bayne, lomita, CA (US)

(21) Appl. No.: 18/752,745

(22) Filed: Jun. 24, 2024

Related U.S. Application Data
(60) Provisional application No. 63/642,855, filed on May 5, 2024.

(51) Int. Cl. H02J 9/00; G05B 19/042

(52) U.S. Cl. CPC H02J 9/005; G05B 19/0426

(57) ABSTRACT

The present invention discloses an energy saving system and method for use in a residential or commercial building. The system includes a main electrical panel, a relay switch assembly, an electrical subpanel, and a power outlet. The power outlet is connected to the subpanel. The relay switch assembly connects the main electrical panel to the electrical subpanel and includes a wirelessly programmable relay switch that operates to automatically disconnect and reconnect an electrical current from the main panel to the subpanel and power outlet to prevent an electronic device, that is turned off and plugged into the outlet, from using external standby power.

### FIELD OF INVENTION

The present invention relates to an energy saving system and method. More particularly, the present invention relates to saving electrical power characterized by the action undertaken by preventing the use of external power by connected common household/business electronics when they are turned off.

### BACKGROUND

People often leave an electrically operated device plugged into a power outlet when the device is not in use. A problem is that even when such a device's interface (e.g., “on/off” button) is turned “off”, or the device is not performing it's primary function, it often consumes electrical energy called “standby power” while idle. This is a source of wasted electricity. For example, standby power may be consumed by remote control receivers, lighted displays of an electrically operated device.

Standby power makes up a portion of a homes' miscellaneous electric load, which includes small appliances (e.g., digital cable boxes, game consoles, etc.), security systems, and other small power draws. The increased energy consumption results in a costlier energy bill. Further, there is an additional risk of fire from devices in standby mode. In a broader context, some estimate that standby power accounts for more than 100 billion kilowatt-hours (kWh) of annual U.S. electricity consumption.

Attempts to address energy savings include “Smart automatic standby power cut-off switching apparatus” (South Korean Patent No. KR101073809B1) which teaches in relevant part, “The smart standby power cut-off . . . by first automatically setting the electric reference value for the standby power . . . ” and “ . . . issues [an] audio and visual alarm when load power is overloaded, so that the user can adjust the load control and detects the effective power amount of the power system to which multiple loads are connected in real time more efficiently.”

“CONTROL METHOD AND CONTROL DEVICE OF APPARATUS AND APPARATUS USING CONTROL DEVICE” (US publication No. US.2022/0026096 A1)), Huang et al. discloses a control method, a control device of an apparatus and an apparatus using the control. The control method includes detecting whether an outdoor unit of the apparatus enters a standby state and controlling the outdoor unit to enter a low power consumption mode for controlling a drive of the outdoor unit to be powered off after detecting that the outdoor unit enters the standby state. Huang, et al does not address standby power in household electronics (e.g. digital cable box), but only for a specialized apparatus (i.e., a multi-split air conditioner) that includes a “drive circuit”, an “outdoor unit detection circuit”, etc., and additionally teaches a method requiring a “discovery” (i.e., detecting) step.

“Concentric plug for blocking standby power” (South Korean Patent No. KR101848723B1) relates to a socket for dormant power shutdown, and more particularly to a docking socket for dynamically determining (i.e., detecting) a standby power reference value used for shutting off an output power according to a power source device connected to an outlet, which is capable of shutting off the power output to the standby power interrupter.

“Standby power controller communications apparatus and method” (WIPO PCT application No. WO2016115590A1), GELONESE, et al, relates to a standby power controller (SPC) having data communication capability. The SPC operates to remove the power supply from a monitored and controlled outlet and the electronic device attached to it, whenever the electronic device is detected to not be in use. In general, GELONESE, et al, teaches an energy detecting scheme to initiate the removal of power by operation of a switch or relay in or associated with the SPC.

“Appliance control system” (U.S. Pat. No. 4,418,333A), Schwarzbach, et al relates to an appliance control system including a central control unit and a plurality of slave units each including a user-programmable microprocessor and respectively plugged into outlet sockets of a power main in a building. For example, a “means for sensing the intensity level of the light intensity . . . means responsive to said preset signal” and “setting said light intensity control means to a predetermined intermediate intensity level.”

Although the prior art provides systems for monitoring, sensing, signaling, and detecting energy consumption and provides devices to inhibit standby power usage, they fail to provide a system that enables the automatic disconnection and reconnection of a power supply to an electronic device in a standby power/inactive state. Thus, there is a need to provide a more efficient system that does not require detecting power usage for energy savings.

### SUMMARY OF THE INVENTION

In accordance with the present invention, the disadvantages and limitations of the prior art are overcome by providing an energy saving system that prevents the use of standby power from an external electric source by common household or business electronics, as well as terminating all electricity flow to an outlet.

A main electrical (circuit) panel (also called a “primary panel”) is the point where power from a utility company enters a home or business from a meter. A subpanel (NEC “Remote Panel”) is a smaller service panel that derives power from the main panel via two poles circuit breakers and is connected to the main panel via a feeder cable that operates as an intermediary between the main panel and circuits in a home or business to enable power distribution to specific areas of the home or building.

A switch is an electrical component that can connect (make), or disconnect (break), the conducting path in an electrical circuit to establish or interrupt the electric current. A relay is an electrically operated switch that opens and closes circuits by receiving electrical signals from an outside source. As used herein, the term “switch” and “relay” are used interchangeably, unless specified otherwise. Relay technology can be divided broadly into two main categories, namely a relay including movable contacts (mechanical relay) and a relay having no movable contacts (e.g., MOS FET relay, solid state relay). Mechanical relays have contacts that are mechanically actuated to open/close by a magnetic force to switch signals, currents and voltages ON or OFF. No movable contacts relays employ semiconductor and electrical switching elements. By the operation of these electronic circuits, signals, currents and voltages are switched ON or OFF electronically. How a main electrical panel, subpanel and a relay works is well known to those having ordinary skill in the art and are not discussed in further detail herein.

In a preferred embodiment, the invention includes an energy saving system, comprising a main electrical panel, a relay switch assembly, a subpanel, and a power outlet. The relay switch assembly further comprises a first conductor cable attachment point for receiving current from the main electrical panel, a second conductor cable attachment point to transmit the electrical current to the subpanel, and a remotely programmable relay switch. The relay switch assembly may be connected in between the main electrical panel and the subpanel (e.g., in a “daisy chain”), or be connected in an alternate code compliant configuration for the relay switch assembly to safely transmit the current from the main panel to the subpanel. A power outlet is connected to the subpanel. The outlet is for use by an electrically operated device that uses standby electricity when the device is turned off and that is not normally used during a programmed/predefined (no power) period.

The remotely programmable relay switch is wirelessly programmed to operate automatically at a programmed time to disconnect the subpanel from the main panel to prevent an electronic device from using standby power when the electronic device is plugged into the outlet connected to the subpanel. The remotely programmable relay switch is likewise wirelessly programmed to automatically reconnect the current flow at a programmed time.

In this way, the energy saving system automatically opens and closes a circuit for a programmed period to cutoff and establish/re-establish electricity supply to the subpanel, outlet, and an electronic device plugged into it (excepting any internal battery in the device).

The system is preferably installed in a new construction environment to maximize energy savings during the life of the structure, as well as to avoid the associated costs (e.g., acquiring permits, paying for inspections, etc.) of upgrading a building's electrical system. However, the system may be installed on and/or in an existing structure as an upgrade to the structure's electrical system (e.g., as part of “a green initiative”).

In alternative embodiment, the present invention includes an energy saving method for an electrical device that uses standby power. The energy saving method comprises the steps of connecting a programmable relay switch of a relay switch assembly in between an electrical main panel and a subpanel, attaching a first conductor cable attachment point to the electrical main panel for the relay switch to receive an electric current from the main electrical panel, attaching a second conductor cable attachment point from the relay switch to the subpanel to transmit the current to the subpanel, and wirelessly programming the programmable relay switch to operate in a predefined time-period to disconnect the current from the main panel to the subpanel for the predefined time period in order to prevent an electronic device from using standby power when it is plugged into an outlet connected to the subpanel.

The relay switch is remotely programmable to automatically disconnect the subpanel from the main panel at a time when the standby power using electronic device will most likely not be in use. For example, while a resident of the building to which the main panel/subpanel provides electricity to is normally away at work, or while the resident sleeps, etc., to avoid wasting “standby power”, and automatically reconnecting the subpanel at the end of the period when the resident is likely home and awake.

The relay switch may additionally offer a menu of preprogrammed options including a range of time(s) from which to select. The relay switch assembly may also include a programmable clock component as a redundancy to the programmable relay switch.

In an alternate embodiment, the relay switch assembly may be a component of the main panel, or subpanel.

The relay switch assembly is preferably powered by the main panel. Alternatively, the relay switch assembly may be powered by an independent power source (e.g., a solar panel, a battery, or alike) instead of the main electrical panel, or may only use an independent power source as a backup.

The programmable relay switch may comprise a micro-switch, micro-controller, micro-processor, or other programmable computer, computer component, timer, or yet to be invented apparatus that is able to perform the functions of a programmable relay switch. The switch is programmable to automatically cut off and reconnect the flow of electricity from the main panel to the subpanel that provides electricity to at least one building outlet.

In a preferred embodiment, the programmable relay switch is remotely programmable by the homeowner, resident, landlord, electricity provider, property manager, landlord, or a government agency via a website, or a wireless mobile app to change the settings (e.g. for daylight savings), manually override the settings, install software upgrades, etc.

In another alternate embodiment, the invention includes an electrical subpanel for a new building construction, comprising a remotely programmable relay switch assembly that further comprises a programmable relay switch that is programmable to automatically open and close a circuit for a programmed period to cutoff and establish/re-establish electricity to at least one power outlet of the building that is connected to the electric subpanel. The circuit open and closed by the relay switch may be a normally closed (NC) circuit, or a normally open circuit (NO).

In a preferred embodiment, each room of a new building construction (excepting where it may be impractical (e.g., a bathroom), or unsafe (e.g., an emergency room)) will have an outlet connected to the energy saving system's subpanel.

A further objective of the present invention is to provide a reprogrammable relay switch that includes a menu of preprogrammed options for a user to choose from, including a range of hours, days (like, Monday to Friday), etc. for the relay to cutoff and establish electricity to the secondary panel.

The energy saving system may include at least one power outlet cover (also called a “wall plate” or “switch plate”) that is distinctively marked (e.g., by a certain color, image, etc.) and/or distinctively shaped (e.g., moon shaped) to communicate to a user visually that it covers an outlet connected to the system and that there will be no electricity available for the programmed period. In effect, warning a user to not use the outlet for an electronic device that requires continuous electricity (e.g., a refrigerator, respirator, etc.).

The energy saving system may include a power outlet cover that includes a visual indicator(s) that matches a plug of an electrically operated device that uses standby electricity (i.e. they share the same/similar visual indicator(s) in the form of a shape, image, color, symbol, word, etc.) for the user to easily identify an electronic device that uses standby electricity and to communicate to the him/her to plug it into an outlet of the system that will stop electricity flowing into the device when it is likely not going to be in use. In this way more people can easily contribute to the saving of electricity.

Additionally, or alternatively, the plug may include a word, symbol, or be of a shape (e.g., the plug is shaped like a pig with contacts sticking out of the snout) to indicate that the device is an “ENERGY PIG” that uses “standby power”, and it should be plugged into an outlet of the energy saving system to avoid wasting standby electricity.

Other objectives and aspects of the invention will become apparent from the following detailed description, taken in conjunction with the accompanying drawings, which illustrate, by way of example, the features in accordance with embodiments of the invention.

To the accomplishment of the above and related objects, the invention may be embodied in the form illustrated in the accompanying drawings, attention being called to the fact, however, that the drawings are illustrative only, and that changes may be made in the specific construction illustrated, and the manner described, that are within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as a single element. In some examples, an element shown as an internal component in one drawing may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1A illustrates an energy saving system in accordance with the present invention;

FIG. 1B illustrates a circuitry diagram of the energy saving system in accordance with the present invention; and

FIG. 2 illustrates an energy saving method in accordance with the present invention.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention by one having ordinary skill in the art have not been described in detail, so as not to unnecessarily obscure the present invention.

It should be noted that any feature or component described in association with a specific embodiment may be used and implemented with any other embodiment, unless clearly indicated otherwise.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. These headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any system or method similar or equivalent to those described herein can be used in the practice or testing of embodiments of the present disclosure, the preferred, systems and methods are now described.

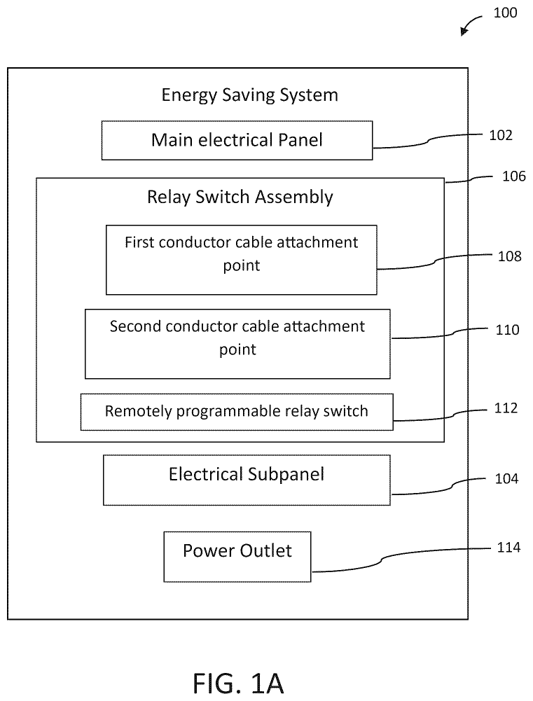

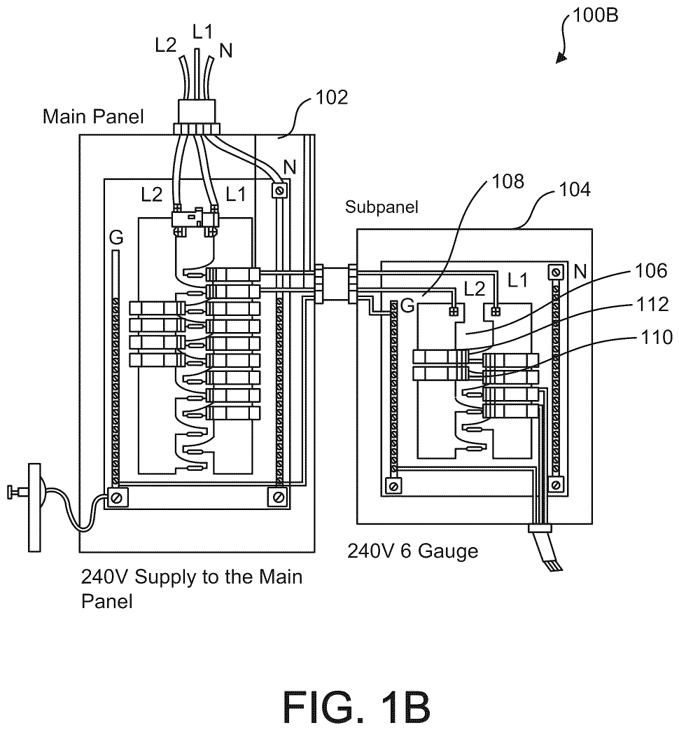

FIG. 1A illustrates an energy saving system (100) that prevents the use of external standby power by a common household or business electronic device (e.g., a digital cable box, a copy machine, etc.). The energy saving system (100) in a preferred embodiment comprises a main electrical panel (102), that is the point where power from a utility company enters a home or business from a meter, a subpanel (104), a relay switch assembly (106), and a power outlet (114). The relay switch assembly (106) derives power from the main electrical panel (102) via the relay switch assembly (106). The relay switch assembly (106) includes a first conductor cable attachment point (108) for receiving current from the main electrical panel (102) and a second conductor cable attachment point (110) to transmit the electrical current to the subpanel (104).

Further, the relay switch assembly (106) is connected in between the main electrical panel (102) and the subpanel (104) and includes a remotely programmable relay switch (112). “In between” means in the sense of the relay switch assembly (106) acting as a bridge to pass on electricity from the main panel (102) to the subpanel (104), and not necessarily configured in physically aligned row or column. The remotely programmable relay switch (112) is programmed wirelessly to operate at a predefined time to disconnect the subpanel (104) from the main panel (102) to prevent use of the standby power by the electronic device. The remotely programmable relay switch (112) is likewise programmed to automatically reconnect and provide current flow from the main electrical panel (102) to the subpanel (104).

In a preferred embodiment, the programmable relay switch assembly (106) is powered by the main electrical panel (102). In addition to, or instead of being powered by the main panel (102), the programmable relay switch assembly (106) may be powered by a battery (not shown), or a solar panel (not shown). The programmable relay switch (112) may be programmed remotely by a power company, a governmental agency, or an individual via a wireless mobile application, a website, or through a wireless network, VPN, etc. The predefined time is measurable in seconds, minutes, hours, days, and/or ranges thereof (e.g., 0900 hours to 1700 hours). The programmable relay switch (112) may include a menu of preprogrammed options, including a day and/or time range, to be selected by a user for a quick set-up.

The energy saving system (100) includes at least one power outlet (114) connected to the subpanel (104). The relay switch (112) can automatically cut off and reconnect electricity to the subpanel (104) and the power outlet (114) connected to the subpanel (104). The power outlet (114) is for use by an electrically operated device that uses standby electricity when the device is turned off and is not normally used during a programmed, or selected, no power period. In this way, an electronic device that uses standby power that is plugged into the power outlet (114) will receive no external electrical current.

For example, the relay switch (112) may be remotely programmable to automatically disconnect the subpanel (104) from the main electrical panel (102) at a time when the electronic device will most likely not be in use. For example (e.g., Monday-Friday, 8:00 AM to 5:30 PM while a resident may be away at work, or 11:00 PM-6:00 AM while the resident sleeps) to prevent the device from wasting “standby power”, and automatically reconnecting the subpanel (104) and providing electricity to the outlet (114) connected to the subpanel (104) at the end of the period when the resident is at home and awake.

The relay switch (112) may come with a menu of preprogrammed options for a user to choose from (e.g., options displayed via a mobile wireless app, or on a utility provider's website), including a range of hours (e.g., 8:00 AM to 5:30 PM, 11:00 PM to 5:00 AM), days of the week (e.g., Monday to Friday), etc. for the relay switch (112) to cutoff electricity to the subpanel 104). Providing a menu of preprogrammed time ranges to select from assists a user in a quickly setting up the system (100) to save electricity. Times/days can be modified later.

The energy saving system (100) is for use by an electrically operated device that uses standby power when the device is turned off and plugged into an outlet (114) that is connected to the subpanel (104) of the system (100).

FIG. 1B illustrates a circuitry diagram of an alternate embodiment of an energy saving apparatus for use as a component of an energy savings system (100). The energy saving system (100B) comprises a main electrical panel (102) and a sub-panel (104) energy saving apparatus that is connected to the main electrical panel (102). The sub-panel (104) energy saving apparatus includes a relay switch assembly (106) that is mounted in the subpanel (104). The sub-panel (104) and relay switch assembly (106) derive power from the main electrical panel (102). The relay switch assembly (106) may be attached to the subpanel (104) in a segregated compartment of the subpanel (104) or partitioned from other subpanel (104) components by a metal wall within the subpanel (104), or another suitable configuration that conforms to a local/national safety code.

The relay switch assembly (106) includes a first conductor cable attachment point (108) for receiving current from the main electrical panel (102). The relay switch assembly (106) includes a second conductor cable attachment point (110) to transmit the electrical current to the subpanel (104). Further, the relay switch assembly (106) includes a remotely programmable relay switch (112). The remotely programmable relay switch (112) is programmed wirelessly to operate at a predefined time to disconnect the subpanel (104) from the main panel (102) to prevent use of the standby power by an electronic device (e.g., from 11:00 PM-5:30 AM, Monday through Friday) connected to an outlet (114) that is connected to the subpanel (104). The energy saving system 100B is likewise remotely programmable to automatically reconnect and provide flow of the current from the main electrical panel (102) to the subpanel (104).

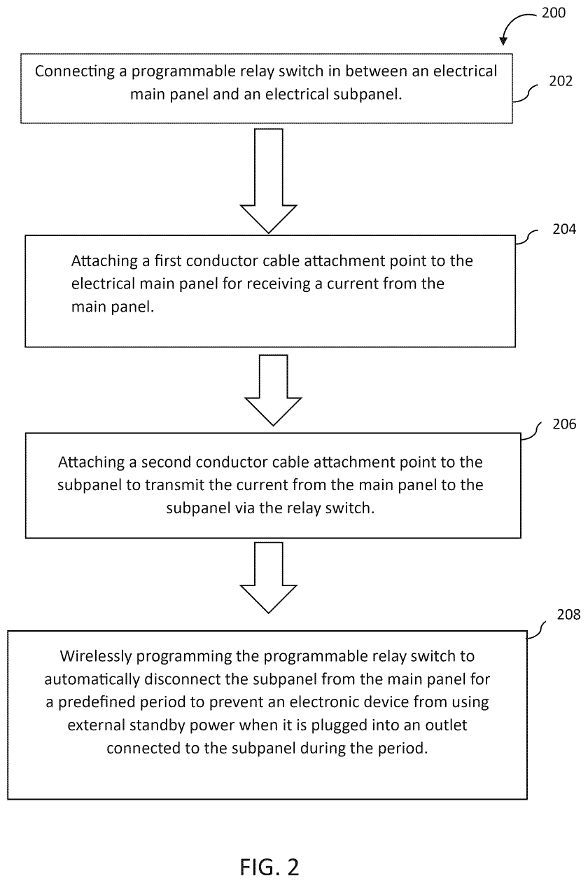

FIG. 2 illustrates an energy saving method (200) for an electrical device using a standby power. The energy saving method (200) includes a step (202) of connecting a programmable relay switch (112) (e.g., as part of a relay switch assembly (106)) in between an electrical main panel (102) and a subpanel (104). The energy saving method (200) includes a step (204) of attaching a first conductor cable attachment point (108) to the electrical main panel (102) and switch (112) for receiving current from the main electrical panel (102). Further, the energy saving method (200) includes a step (206) of attaching a second conductor cable attachment point (110) from the switch (112) to the subpanel (104) to transmit the current from the main panel (102) to the subpanel (104) via the switch (112). Further, the energy saving method (200) includes a step (208) of wirelessly programming the relay switch 112 to disconnect the subpanel (104) from the main panel (102) for a predefined time period to prevent an electronic device from using standby power when it is plugged into an outlet (114) connected to the subpanel (104).

The outlet (114) is for use by an electrically operated device that uses standby electricity when the device is turned off and is not normally used during a preprogrammed/selected (no power) period. In this way, any electronic device that uses standby power, when plugged into the power outlet (114), will receive no external electrical current.

The present invention does not require any detecting of electrical usage before cutting off electricity, but instead cuts off electricity/re-establishes electricity based on a human's need of sleep and the fact that many people work outside the home, or are remote working part-time, to allow a user to remotely choose in advance (or change an existing choice) when no electrical power will be available for use by an electronic device plugged into an outlet (114) of the system 100/100B (excepting any internal battery of the electronic device), as well as automatically making electricity available again at the outlet (114).

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

Lastly, it is intended that the invention includes any improved relays, switches, main electrical panels, and electrical subpanels that are developed in the future that can substantially perform, individually, or in combination, the function(s) of the disclosed invention.

I claim:

1. An energy saving system for preventing external standby power use by an electronic device, the energy saving system comprises:
a main electrical panel;
a subpanel connected to the main electrical panel; and
a relay switch assembly, wherein the relay switch assembly further comprises
a first conductor cable attachment point for receiving current from the main electrical panel;
a second conductor cable attachment point to transmit the electrical current to the subpanel; and
a remotely programmable relay switch connected in between the main electrical panel and the subpanel, wherein the remotely programmable relay switch is wirelessly programmed to operate for a predefined time period to disconnect the subpanel from the main panel based on the predefined time period to prevent an electronic device from using external standby power when it is plugged into an outlet connected to the subpanel.

2. The energy saving system in accordance with claim 1, wherein the energy saving system further comprises a power outlet connected to the subpanel.

3. The energy saving system in accordance with claim 1, wherein the programmable relay switch assembly is powered by the main electrical panel.

4. The remotely programmable relay switch of claim 1, wherein the remotely programmable relay switch is programmable to automatically reconnect and provide current flow from the main electrical panel to the subpanel.

5. The energy saving system in accordance with claim 1, wherein the programmable relay switch assembly is powered by a battery.

6. The energy saving system in accordance with claim 1, wherein the programmable relay switch assembly is powered by a solar panel.

7. The energy saving system in accordance with claim 1, wherein the programmable relay switch assembly is programmed remotely by a power company or a governmental agency.

8. The energy saving system in accordance with claim 1, wherein the programmable relay switch assembly is remotely programmed via a group, the group including one of a wireless mobile application, a website, or a wireless network.

9. The energy saving system in accordance with claim 1, wherein the predefined time period is in seconds, minutes, hours, days, or a combination thereof.

10. The energy saving system in accordance with claim 1, wherein the programmable relay switch assembly includes a menu of pre-programmed options, including a time range to be selected by a user.

11. The programmable relay switch of claim 1, further being operable to open a normally closed circuit.

12. The energy saving system in accordance with claim 1, further being installed in a new construction environment.

13. The energy saving system in accordance with claim 1, further comprising external standby power provided by a utility provider.

14. An energy saving method for an electrical device using external standby power, wherein the energy saving method comprises the steps of:
connecting a programmable relay switch in between an electrical main panel and a subpanel;
attaching a first conductor cable attachment point to the electrical main panel for the relay switch to receive an electric current from the main electrical panel;
attaching a second conductor cable attachment point from the relay switch to the subpanel to transmit the current to the subpanel; and
wirelessly programming the programmable relay switch to automatically disconnect the electric current from the main panel to the subpanel for a predefined time to prevent an electronic device from using external standby power when it is plugged into an outlet connected to the subpanel during the predefined time.

15. The method of claim 14, further comprising the additional step of wirelessly programming the programmable relay switch to automatically reconnect the electric current from the main panel to the subpanel for a predefined time.

16. The method of claim 14, wherein the wireless programing is affected by the additional step of selecting an option from a preprogrammed menu of time range options.

17. A subpanel for use in an energy saving system, comprising:
an electrical subpanel; and
the subpanel further comprising a programmable relay switch to automatically open a normally closed circuit of the subpanel to stop an electrical current to an outlet of a building connected to the subpanel.

18. The relay switch of claim 17, further being remotely programmable.

19. The relay switch of claim 17, further being remotely programmed to automatically close the circuit it has opened.

20. The programmable relay switch of claim 17, further comprising a preprogrammed menu of options to choose from, the options further comprise a day of the week and a time range.
